(19) United States
(12) Patent Application Publication
(10) Pub. No.: US 2023/0389489 A1
(43) Pub. Date: Dec. 7, 2023

(54) IRRIGATION OLLA

(71) Applicant: Thirsty Earth, LLC, Bountiful, UT (US)

(72) Inventor: Jared Russel Orvis, Salt Lake City, UT (US)

(21) Appl. No.: 17/830,491

(22) Filed: Jun. 2, 2022

(51) Int. Cl. A01G 25/00

(52) U.S. Cl. CPC A01G 25/00

(57) ABSTRACT

An irrigation device. The irrigation device includes a cup. The cup is configured to seep liquid from an interior surface of the cup to an exterior surface of the cup. The irrigation device includes a seal configured to seal the cup. The irrigation device includes an inlet coupled to the cup. The inlet is configured to allow liquid to be provided to the interior of the cup. The irrigation device includes an outlet coupled to the cup. The outlet is configured to prevent pressures in the cup from exceeding a particular threshold, while also hindering liquid losses.

### BACKGROUND

### Background and Relevant Art

Fresh water is a precious and limited resource. This is particularly true with respect to domestic water supplied to regions with ever increasing populations and water demands. Some studies have suggested that one of, if not the largest consumer of water resources is agriculture. Indeed, even domestic gardening can consume massive amounts of water. Domestic water use is often billed by municipalities at high rates as compared to commercial agriculture usage. Further, domestic water may be limited on a per user basis. Thus, individuals who wish to grow their own produce and other vegetation are faced with high costs and/or prohibitive limitations that discourage or prevent such activities. Further, individuals may have principled and ethical motivations to conserve water.

Various techniques exist to conserve water in domestic crop production. However, these techniques often require significant time commitments. For example, an individual could manually water individual plants to prevent excess water consumption. This has the drawback of a plant having sporadic water supplied to it in that large amounts of water are available to the plant when first suppled while gradually less and less water is available to the plant. Further, much of the supplied water will be lost to evaporation and leeching away from the plant. Further still, significant amounts of time are required to attend to watering plants.

One ancient technology that has been used to water plants is olla technology. An olla is an earthenware pot or jar that can become saturated with water, and when buried in the ground can slowly cause water to seep out for watering a plant. While somewhat more efficient than manual watering, an olla still requires an individual to manually fill the olla. Thus, better systems of watering are needed.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

One embodiment illustrated herein includes an irrigation device. The irrigation device includes a cup. The cup is configured to seep liquid from an interior surface of the cup to an exterior surface of the cup. The irrigation device includes a seal configured to seal the cup. The irrigation device includes an inlet coupled to the cup. The inlet is configured to allow liquid to be provided to the interior of the cup. The irrigation device includes an outlet coupled to the cup. The outlet is configured to prevent pressures in the cup from exceeding a particular threshold, while also hindering liquid losses.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates an assembly view of an irrigation olla;

FIG. 2 illustrates an exploded view of an irrigation olla;

FIG. 3 illustrates a view of an irrigation olla planted in earth to water a plant;

FIG. 4 illustrates top, side, and bottom views of an irrigation olla cup;

FIG. 5 illustrates a perspective view of an irrigation olla cup;

FIG. 6 illustrates a perspective view of an irrigation olla cup having pinholes formed therein;

FIG. 7 illustrates top, side, and bottom views of a plug for an irrigation olla;

FIG. 8 illustrates top, side, front and bottom views of a cap for an irrigation olla;

FIG. 9 illustrates a perspective view of a cap for an irrigation olla;

FIG. 10 illustrates perspective, front, and bottom views of a rubber seal;

FIG. 11 illustrates a method of irrigation; and

FIG. 12 illustrates a method of manufacturing an irrigation device.

### DETAILED DESCRIPTION

Embodiments illustrated herein are directed to a specialized irrigation device, such as an olla, that is configured to be refilled using automatic watering systems. In particular, some embodiments include an olla cup made of a porous material configured to seep liquid (such as water) into earth. The olla cup is coupled to an inlet opening that allows liquid to be provided into the interior of the olla cup, whereafter the liquid can seep into earth. The olla cup is also coupled to an outlet that is configured to prevent pressures from being too high in the olla. Further, the outlet is configured to hinder liquid losses from the outlet. This can be done by including obstructions in the outlet, causing the outlet to be of a size that is difficult for the liquid to overcome surface tension of the liquid. Alternatively, the outlet may be configured in size, shape, and construction to reduce or eliminate evaporation. Additional details are now illustrated.

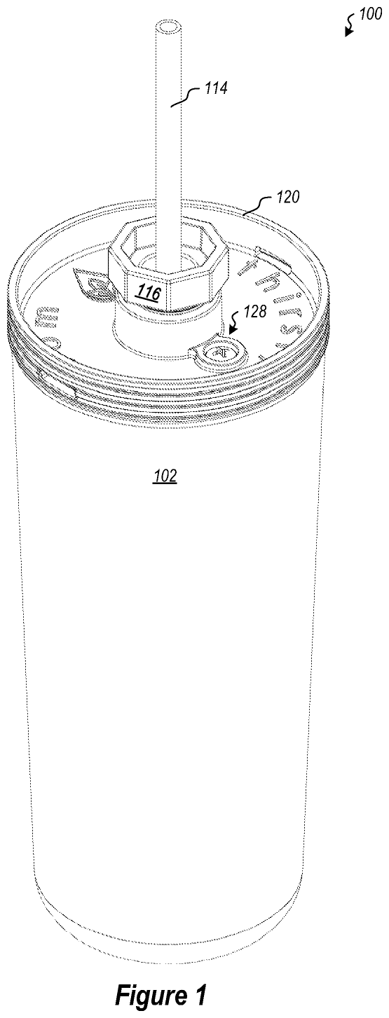

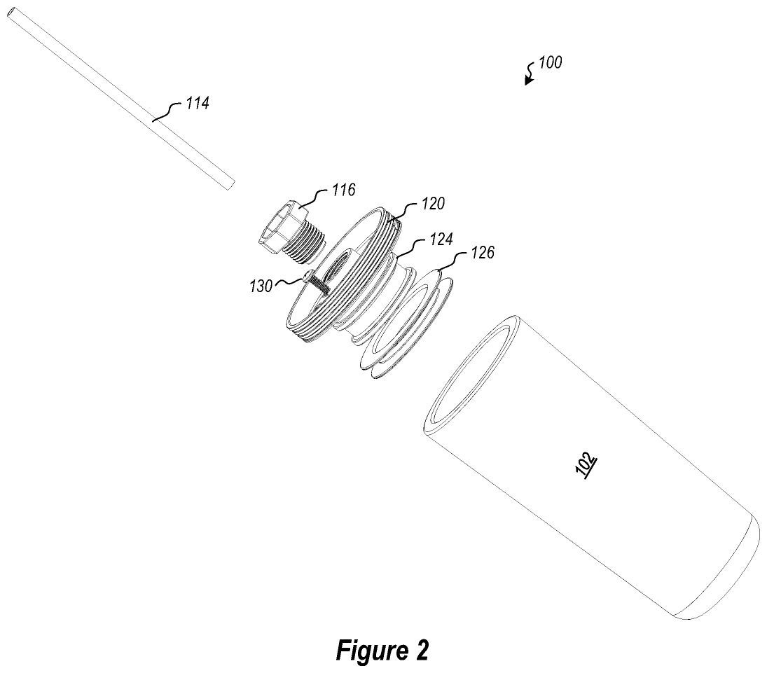

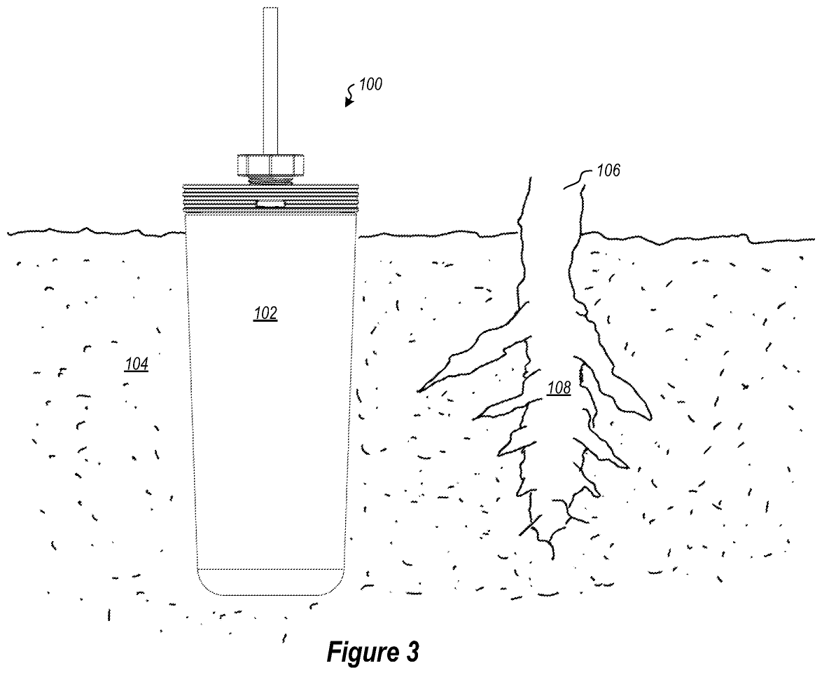

Referring now to FIG. 1 and FIG. 2, an example is illustrated. FIG. 1 illustrates a perspective view of an olla 100, while FIG. 2 illustrates an exploded view of the olla 100. FIG. 1 illustrates an olla cup 102. The olla cup 102 is generally constructed of a porous material. For example, the olla cup 102 may be constructed of earthenware materials such as unglazed ceramic, pottery clay, stone, or other similar materials. Such materials allow liquid to diffuse throughout the material of the olla cup 102. That is, earthenware materials act as sort of a sponge in that they absorb liquid and diffuse the liquid in a generally even fashion throughout the earthenware materials. This results in the liquid permeating the olla cup 102 and being generally available to environments external to the olla 100. For example. FIG. 3 illustrates the olla 100 in soil 104 where a plant 106 is planted. The olla 100 provides liquid from inside the olla cup 102 to the soil 104 and to the root system 108 of the plant 106 by slowly seeping liquid from the olla cup 102.

The olla cup 102 may be one or more of a number of different materials. For example, in some embodiments as illustrated above, the olla cup 102 may comprise earthenware materials. In an alternative example, the olla cup 102 may be made of polymers where the polymers are selected to have a particular pre-determined permeability, solubility, and/or diffusivity. Indeed, in some embodiments, these properties may be selected based on pressures (as will be described in more detail below) of liquid and/or configuration of a pressure relieving outlet.

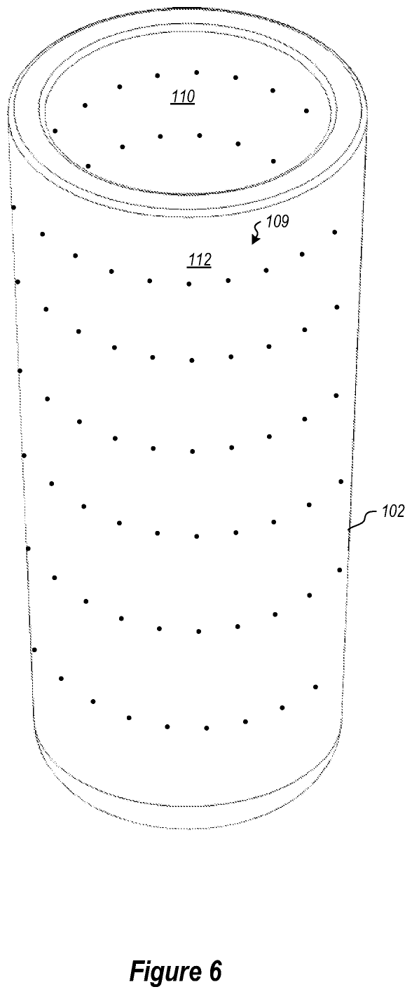

In some embodiments, a polymer or other material with low permeability or diffusivity may be selected, but the ability of the material to seep liquid into soil may be bestowed by forming “pinholes” through the material. Examples of this are illustrated in FIG. 6. Thus, while a material may be selected that does not inherently have the ability to seep liquid at a sufficient rate to provide sufficient liquid to a plant, the ability to seep liquid can be enhanced by physical modification of the olla cup 102 after formation to add openings 109 (typically pinhole in size) to allow liquid to seep from an interior surface 110 to an exterior surface 112 of the olla cup.

Note that in some embodiments, the pinholes may be sized and/or numbered to achieve a particular seepage rate. Thus, for example, the olla cup 102 may have larger or more holes for when specially designed for certain water intensive plants but smaller and/or fewer holes when specially designed for other plants that are less water intensive.

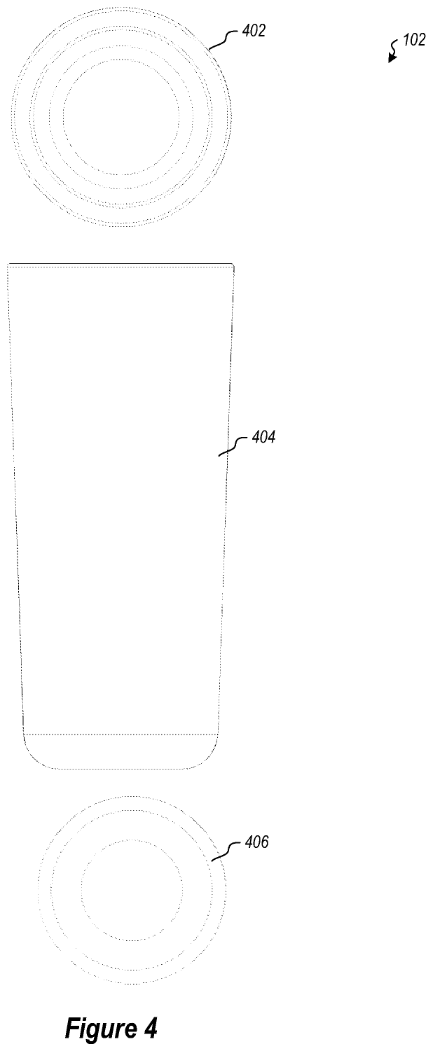

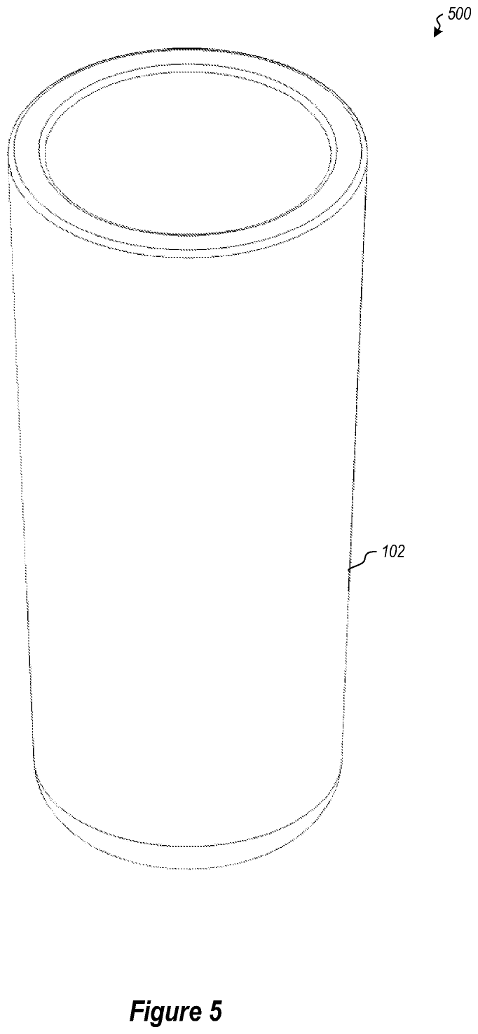

Additional views of the olla cup 102 are illustrated in FIG. 4 and FIG. 5. FIG. 4 illustrates a top view 402 of the olla cup 102, a side view 404 of the olla cup 102, and a bottom view 406 of the olla cup 102. FIG. 5 illustrates a perspective view 500 of the olla cup 102.

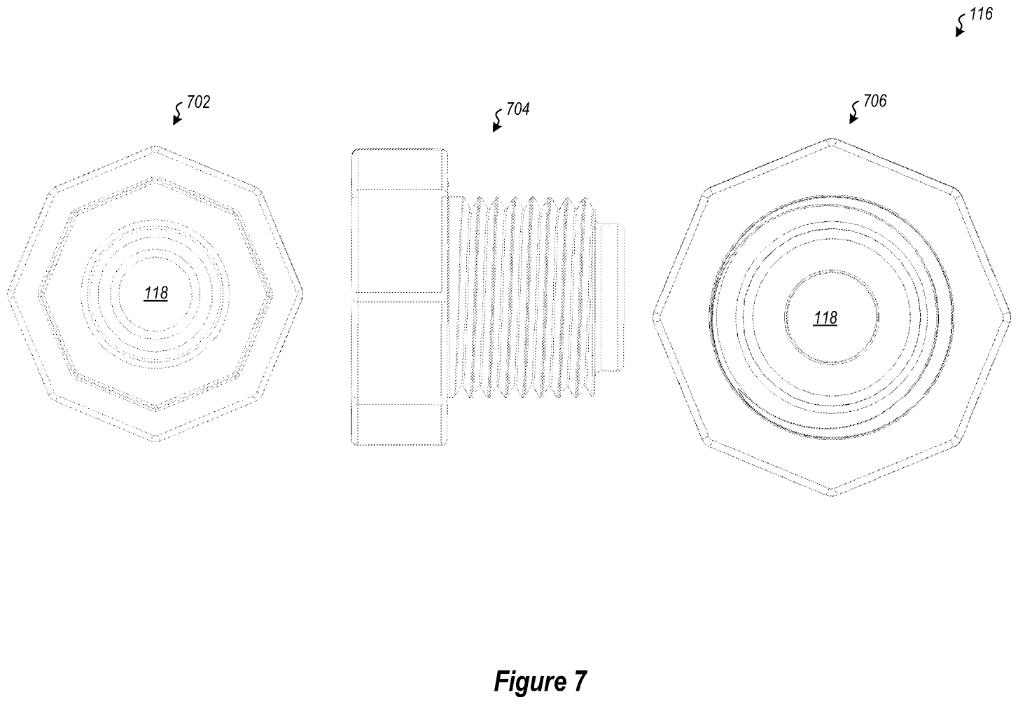

The olla 100 is configured to have liquid supplied from an external liquid source. For example, in some embodiments, liquid may be supplied to the olla 100 from a drip irrigation system. In an alternative example, liquid may be provided using a gravity feed system where a large reservoir feeds the olla 100. FIG. 1 further illustrates a tube 114. The tube 114 is configured to connect to an irrigation system, where the irrigation system provides liquid to the interior of the olla cup 102. In the example illustrated in FIG. 1, the tube 114 passes through an inlet illustrated as an opening 118 (see FIG. 7) of a plug 116. Note that FIG. 7 illustrates a top view 702, a side view 704, and a bottom view 706 of the plug 116.

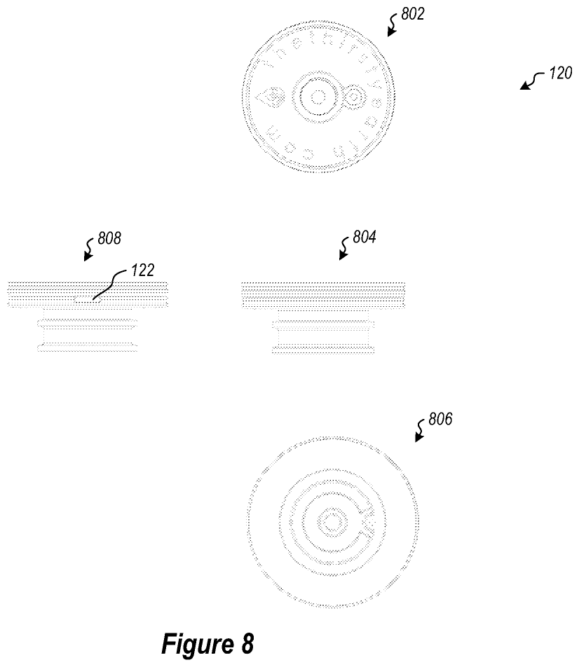

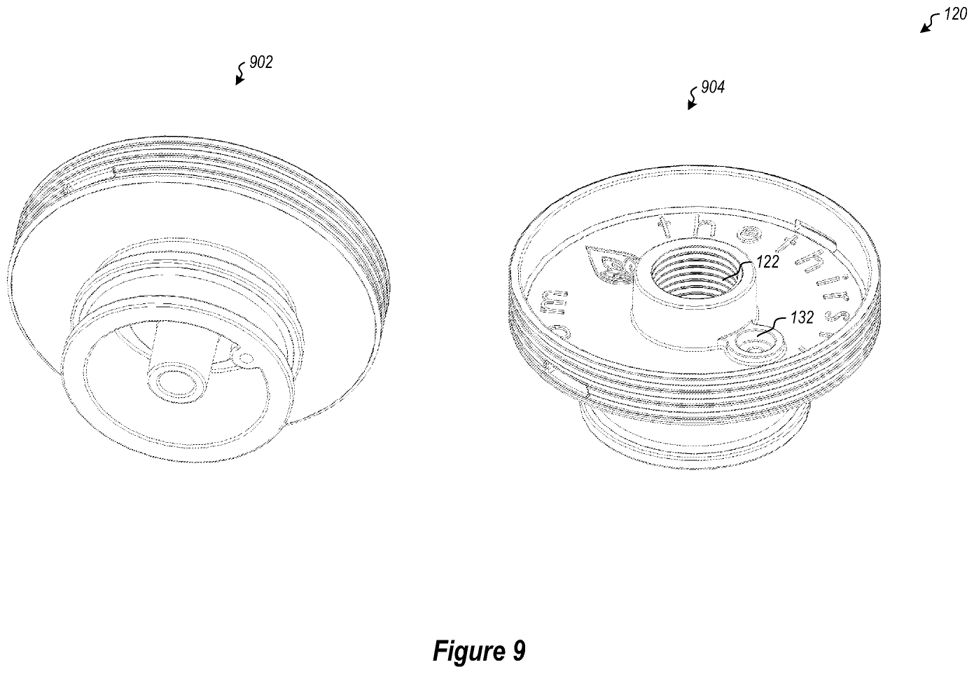

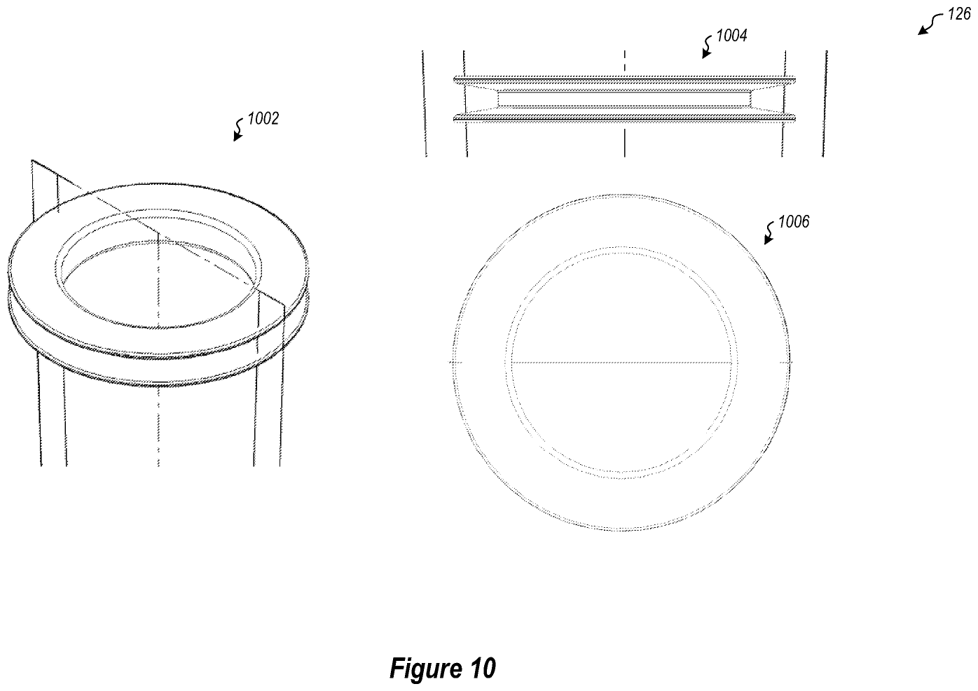

The plug 116 is threaded and configured to be screwed into a threaded opening 122 (see FIG. 9) of a cap 120. Illustrated in FIG. 2, the cap 120 is coupled to rubber gaskets 124 and a rubber seal 126 to allow the cap to form an airtight seal with the olla cup 102. Thus, in some embodiments, the irrigation olla includes a seal comprising the plug 116, the cap 120, the rubber gaskets 124, and the rubber seal 126. Additional detail of the cap 120 is illustrated in FIG. 8, which shows a top view 802, a front view 804, a bottom view 806 and a left side view 808 of the cap 120. FIG. 9 illustrates a bottom perspective view 902 and a top perspective view 904 of the cap 120. The plug 116 and cap 120 may be constructed of polymers or other appropriate materials. FIG. 10 illustrates a perspective view 1002, a side view 1004, and a bottom view 1006 of the rubber seal 126.

Typical drip irrigation systems provide liquid at pressures of approximately 15 psi. However, at these pressures, if liquid is provided to a porous but otherwise closed device, liquid will be forced out of the porous surfaces of the device at a faster rate than is desirable. Thus, embodiments illustrated here include functionality for regulating pressure to prevent pressures from becoming too high within the sealed olla cup 102, causing excessive seepage out of the olla cup 102. For example, FIG. 1 illustrates an outlet 128 that can be adjusted to adjust pressure inside of the olla 100 when the cap 120 is securely fastened to the olla cup 102. In the example illustrated in FIG. 2, the outlet 128 (see FIG. 1) includes a screw 130 (see FIG. 2) secured in a threaded hole 132 (see FIG. 9) in the cap 120. Pressure adjustment can be made by tightening or loosening the screw 130 in the threaded hole 132 to obtain a desired pressure.

In some embodiments, different pressures may be used at different times. For example, in some embodiments, the outlet 128 may be adjusted to have a relatively high pressure (e.g., 8 to 15 PSI) to initialize use of the olla 100 so as to quickly saturate the olla cup 102 material. In some embodiments, the relatively high pressure may be maintained when the olla 100 is originally planted as shown in FIG. 3 to obtain a relatively quick initial saturation of soil around the root system 108 of a plant 106.

Pressure can then be reduced to a desired level by further loosening of the screw 130 in the threaded hole 132. For example, in some embodiments pressure may be reduced such that when liquid is being provided through the tube 114 to the sealed olla cup 102, the liquid is provided such that pressures inside the olla 100 are no more than 1 psi. In other embodiments, the pressure may be selected to be between 1 psi and 3 psi.

Note that in some embodiments, pressure can be limited by in the inlet opening 118 by an input pressure regulator. For example, in some embodiments, a pressure regulator may be coupled to the tube 114 to prevent pressures of liquids entering the cup 102 from exceeding some predetermined pressure. For example, a pressure regulator may prevent pressures entering the cup 102 from exceeding 1 to 3 PSI.

While the example shown in the figures illustrates a simple screw and threaded hole outlet, it should be appreciated that other types of outlets, such as various types of valves can be implemented in other embodiments. For example, various pressure regulators, mechanically activated relief valves, spring loaded valves, etc. may be used. For example, valves may be configured to open when pressure inside the olla exceeds some predetermined value.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

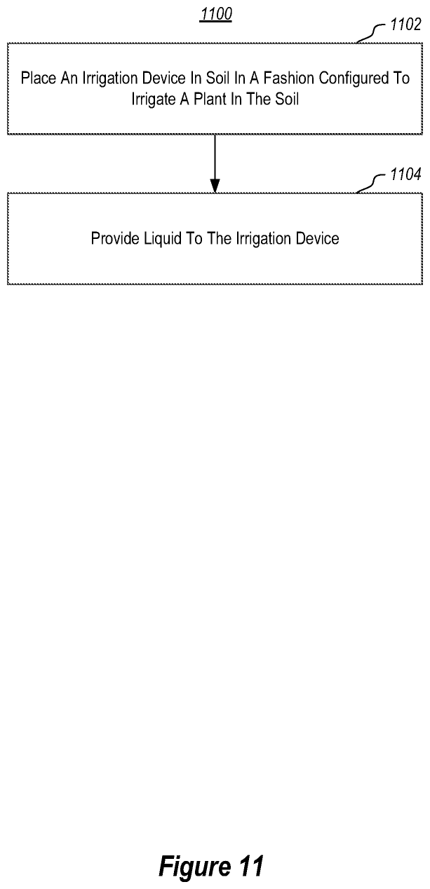

Referring now to FIG. 11, a method 1100 is illustrated. The method 1100 includes act for performing irrigation. The method 1100 includes placing an irrigation device in soil in a fashion configured to irrigate a plant in the soil (act 1102). An example of this is illustrated in FIG. 3.

The method 1100 further includes providing liquid to the irrigation device (act 1104). This is performed by providing liquid to an irrigation device that includes a cup. The cup is configured to seep liquid from an interior surface of the cup to an exterior surface of the cup. Further, the irrigation device includes a seal configured to seal the cup. In some embodiments, the seal includes a plug, cap, rubber gasket(s), and a rubber seal as illustrated herein, but may be implemented in other fashions in other embodiments. The irrigation device includes an inlet coupled to the cup. The inlet is configured to allow liquid to be provided to the interior of the cup. While the inlet is illustrated as being formed by the opening 118 in the plug herein, in other embodiments, the inlet may be formed in other locations. For example, the inlet may be directly coupled to the cup. The irrigation device comprises an outlet coupled to the cup. The outlet is configured to prevent pressures in the cup from exceeding a particular threshold, while also hindering liquid losses. While the outlet is illustrated as being formed in the plug herein, in other embodiments, the outlet may be formed in other locations. For example, the outlet may be directly coupled to the cup.

The method 1100 may be practiced where providing liquid to the irrigation device includes providing liquid at a first pressure to the irrigation device to saturate the cup with the liquid and subsequently providing liquid at a second lower pressure to the irrigation device after the cup is saturated.

The method 1100 may be practiced where providing liquid to the irrigation device comprises providing liquid at a first pressure to the irrigation device to saturate soil around the cup with the liquid and subsequently providing liquid at a second lower pressure to the irrigation device after the soil is saturated.

The method 1100 may be practiced where providing liquid to the irrigation device comprises providing liquid at a first pressure to the irrigation device, where the first pressure is limited to a pressure below 1 psi as a result of the outlet preventing pressures in the cup from exceeding a particular threshold.

The method 1100 may be practiced where providing liquid to the irrigation device comprises providing liquid at a first pressure to the irrigation device, where the first pressure is limited to a pressure between 1 psi and 3 psi as a result of the outlet preventing pressures in the cup from exceeding a particular threshold.

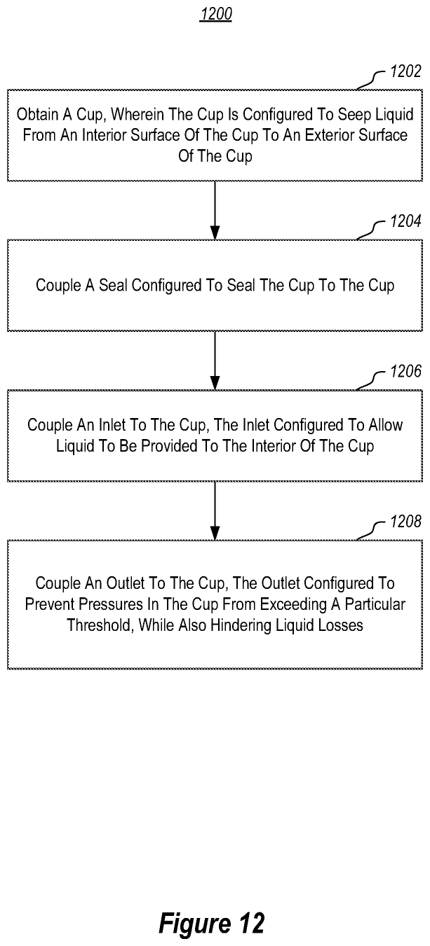

Referring now to FIG. 12, a method 1200 is illustrated. The method 1200 includes acts for manufacturing an irrigation device. The method 1200 includes obtaining a cup, wherein the cup is configured to seep liquid from an interior surface of the cup to an exterior surface of the cup (act 1202). The method 1200 may be practiced where obtaining a cup comprises obtaining an earthenware cup. The method 1200 may be practiced where obtaining a cup comprises obtaining a clay cup. The method 1200 may be practiced where obtaining a cup comprises obtaining a stone cup. The method 1200 may be practiced where obtaining a cup comprises obtaining a polymer cup. The method 1200 may be practiced where obtaining a cup comprises obtaining a cup having pinhole openings formed in the cup to allow the liquid to seep from the interior surface of the cup to the exterior surface of the cup.

The method 1200 further includes coupling a seal configured to seal the cup to the cup (act 1204). In the examples illustrated herein, this is performed by attaching a plug, cap, rubber gasket(s), and a rubber seal as illustrated herein, but may be accomplished in other fashions.

The method 1200 further includes coupling an inlet to the cup, the inlet configured to allow liquid to be provided to the interior of the cup (act 1206). In the embodiments illustrated herein, this may be accomplished by attaching the cap 120 and plug 116 having the opening 118 to the olla cup 102, but may alternatively be accomplished in other fashions.

The method 1200 further includes coupling an outlet to the cup, the outlet configured to prevent pressures in the cup from exceeding a particular threshold, while also hindering liquid losses (act 1208). In the embodiments illustrated herein, this may be accomplished by attaching the cap 120 having the outlet 128 to the olla cup 102, but may alternatively be accomplished in other fashions. The method 1200 may be practiced where coupling an outlet coupled to the cup comprises placing a screw in a threaded hole.

The present invention may be embodied in other specific forms without departing from its characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An irrigation device comprising:
a cup, wherein the cup is configured to seep liquid from an interior surface of the cup to an exterior surface of the cup;
a seal configured to seal the cup;
an inlet coupled to the cup, the inlet configured to allow liquid to be provided to the interior of the cup; and
an outlet coupled to the cup, the outlet configured to prevent pressures in the cup from exceeding a particular threshold, while also hindering liquid losses.

2. The irrigation device of claim 1, wherein the cup is an earthenware cup.

3. The irrigation device of claim 1, wherein the cup is a clay cup.

4. The irrigation device of claim 1, wherein the cup is a stone cup.

5. The irrigation device of claim 1, wherein the cup is a polymer cup.

6. The irrigation device of claim 1, wherein the cup has pinhole openings formed in the cup to allow the liquid to seep from the interior surface of the cup to the exterior surface of the cup.

7. The irrigation device of claim 1, wherein the outlet comprises a screw and threaded hole.

8. The irrigation device of claim 1, wherein the outlet comprises a pressure relief valve.

9. A method of irrigation, the method comprising:
placing an irrigation device in soil in a fashion configured to irrigate a plant in the soil; and
providing liquid to the irrigation device, that includes a cup, wherein the cup is configured to seep liquid from an interior surface of the cup to an exterior surface of the cup; a seal configured to seal the cup; an inlet coupled to the cup, the inlet configured to allow liquid to be provided to the interior of the cup; and an outlet coupled to the cup, the outlet configured to prevent pressures in the cup from exceeding a particular threshold, while also hindering liquid losses.

10. The method of claim 9, wherein providing liquid to the irrigation device comprises providing liquid at a first pressure to the irrigation device to saturate the cup with the liquid and subsequently providing liquid at a second lower pressure to the irrigation device after the cup is saturated.

11. The method of claim 9, wherein providing liquid to the irrigation device comprises providing liquid at a first pressure to the irrigation device to saturate soil around the cup with the liquid and subsequently providing liquid at a second lower pressure to the irrigation device after the soil is saturated.

12. The method of claim 9, wherein providing liquid to the irrigation device comprises providing liquid at a first pressure to the irrigation device, where the first pressure is limited to a pressure below 1 psi as a result of the outlet preventing pressures in the cup from exceeding a particular threshold.

13. The method of claim 9, wherein providing liquid to the irrigation device comprises providing liquid at a first pressure to the irrigation device, where the first pressure is limited to a pressure between 1 psi and 3 psi as a result of the outlet preventing pressures in the cup from exceeding a particular threshold.

14. A method of manufacturing an irrigation device, the method comprising:
obtaining a cup, wherein the cup is configured to seep liquid from an interior surface of the cup to an exterior surface of the cup;
coupling a seal configured to seal the cup to the cup;
coupling an inlet to the cup, the inlet configured to allow liquid to be provided to the interior of the cup; and
coupling an outlet to the cup, the outlet configured to prevent pressures in the cup from exceeding a particular threshold, while also hindering liquid losses.

15. The method of claim 14, wherein obtaining a cup comprises obtaining an earthenware cup.

16. The method of claim 14, wherein obtaining a cup comprises obtaining a clay cup.

17. The method of claim 14, wherein obtaining a cup comprises obtaining a stone cup.

18. The method of claim 14, wherein obtaining a cup comprises obtaining a polymer cup.

19. The method of claim 14, wherein obtaining a cup comprises obtaining a cup having pinhole openings formed in the cup to allow the liquid to seep from the interior surface of the cup to the exterior surface of the cup.

20. The method of claim 14, wherein coupling an outlet coupled to the cup comprises placing a screw in a threaded hole.
